(19) United States
(12) Patent Application Publication
(10) Pub. No.: US 2019/0263307 A1
(43) Pub. Date: Aug. 29, 2019

(54) Multilayer Structure for Producing Floor Covering

(71) Applicant: GERFLOR, Villeurbanne (FR)

(72) Inventors: Olivier Jaudouin, Sourcieux Les Mines (FR); Nicolas Cinausero, Fontaine Saint Martin (FR)

(21) Appl. No.: 16/284,833

(22) Filed: Feb. 25, 2019

(30) Foreign Application Priority Data
Feb. 27, 2018 (FR) 1851723

(51) Int. Cl. B60N 3/04; D06N 7/00

(52) U.S. Cl. CPC B60N 3/048; B60N 3/042; B32B 5/022; D06N 7/0049; D06N 7/006; D06N 7/0042

(57) ABSTRACT

A multilayer structure for the production of a floor covering of a transport vehicle successively includes an upper wear layer of plastic material, a first adhesive layer, a woven reinforcement, a second adhesive layer, a non-woven textile layer comprising self-extinguishing fibers, said layers being bonded together to form the multilayer structure.

### TECHNICAL FIELD

The present disclosure concerns a multilayer structure for the production of a floor covering, particularly for passenger transport vehicles, for example in the aeronautics industry.

### BACKGROUND

It is common in the aeronautics industry to use tufted floor covering, such as carpets, to cover aisles and the areas beneath the seats in aircraft cabins. This type of flooring generally comprises a backing produced from a polymer and a surface layer produced from fiber (wool, polyamide, etc.). However, this flooring is not entirely satisfactory in terms of durability, comfort and cleaning. The flooring laid in the aisles receives particularly heavy use due to carts moving over it. It is therefore common for all the carpets of a cabin to be removed and replaced several times per year. This obviously results in increased operating cost and significant downtime for the aircraft, which is undesirable.

Furthermore, the aesthetic aspect is a factor that is increasingly important for aircraft manufacturers and operators. The use of carpets limits the variety of decor and colors that can be offered. Decorations such as wood imitations are particularly excluded.

Also known from the prior art, in the field of housing, is a multi-layer structure successively comprising a transparent upper wear layer composed of at least polyvinyl chloride (PVC), a printed PVC decorative film and a backing layer produced by impregnation of a PVC plastisol on a non-woven felt textile, the non-woven textile being intended to be in contact with the floor to be covered. This type of covering is commonly used in renovation of floor tiling because it makes it possible to reduce the phenomenon of “telegraphing,” which results in the transmission of irregularities from the support to the floor covering. However, this type of covering cannot be directly used in the aeronautics industry which requires very demanding standards of fire resistance, durability, slipperiness and dimensional stability.

### SUMMARY

One of the purposes of the disclosed embodiments, therefore, is to propose a multilayer structure for the production of a floor covering, particularly for passenger transport vehicles, having good fire-resistant properties, while having better durability than carpets and good properties of cleaning, dimensional stability and limitation of telegraphing.

One of the purposes of the disclosed embodiments is particularly to propose a floor covering that can comply with FAR 25.853 standards.

Another purpose of the disclosed embodiments is to propose a multilayer structure that can have a wide variety of decorations.

To that end, a multilayer structure is proposed for the production of a floor covering of a transport vehicle, said multilayer structure (1) successively comprising an upper wear layer of plastic material, a first adhesive layer, a woven reinforcement, a second adhesive layer, a non-woven textile layer comprising self-extinguishing fibers, said layers being bonded together to form the multilayer structure.

The non-woven textile layer comprises self-extinguishing fibers so as to improve fire resistance of the multilayer structure while improving the walking comfort of the floor covering. Self-extinguishing fibers are generally fibers having an oxygen limiting index (OLI) of more than 0.21 according to NF EN ISO 4589-2/A1 standards. In order to have an oxygen limiting index of more than 0.21, the non-woven textile layer can in particular comprise fibers chosen from among fibers of polyetherimide, polyester, polyacrylate, aramide, para-aramide, oxidized polyacrylonitrile, aromatic polyamide and mixtures thereof. The quantity of each type of fiber can easily be adapted by the person skilled in the art to achieve an oxygen limiting index value greater than 0.21, particularly from oxygen limiting index values of each type of fiber used in producing the non-woven textile layer.

Advantageously, the non-woven textile layer has an oxygen limiting index of more than 0.28 according to NF EN ISO 4589-2/A1 standards. It has been found that the best fire-resistance results for the multilayer structure were obtained with a non-woven textile layer having an oxygen limiting index of more than 0.28 according to the standard NF EN ISO 4589-2/A1. This oxygen limiting index value in particular makes it possible to obtain a floor covering that can comply with the FAR 25.853 standard in terms of fire resistance, without, however, greatly increasing the manufacturing cost of the floor covering.

Advantageously, the non-woven textile layer has an oxygen limiting index of more than 0.32 according to NF EN ISO 4589-2/A1 standards. In particular, this oxygen limiting index value makes it possible to obtain a floor covering that can comply with the FAR 25.853 standard in terms of fire resistance, whether the upper wear layer of the multilayer structure is produced from a self-extinguishing polymer such as PVC, or from another necessarily self-extinguishing polymer such as TPU.

Advantageously, the non-woven textile layer has an oxygen limiting index of less than 0.42, preferably less than 0.40, according to NF EN ISO 4589-2/A1 standards. Although oxygen limiting index values of more than 0.40 are feasible, the materials enabling this to be achieved generally result in increased cost of the floor covering. Preferably, the non-woven textile layer has an oxygen limiting index of between 0.28 and 0.42, and more preferably between 0.32 and 0.40 in order to achieve a good compromise between the manufacturing cost and the fire behavior of the floor covering.

Preferably, the non-woven textile layer comprises fibers chosen from among fibers of polyetherimide, polyester, polyacrylate, aramide, para-aramide, oxidized polyacrylonitrile, aromatic polyamide and mixtures thereof.

In order to improve the comfort of the floor covering while preserving good fire-resistant properties and limiting manufacturing costs, the non-woven textile layer can be produced from a mixture of polyester fibers and polyetherimide fibers, a mixture of polyester fibers and aramide fibers, a mixture of polyacrylate fibers and aramide fibers, a mixture of polyester fibers and aramide fibers, or a mixture of oxidized polyacrylonytrile fibers and para-aramide fibers.

In general, the non-woven textile layer can be bonded to an adhesive sublayer in order to facilitate the laying of the floor covering. The adhesive sublayer can in particular have a backing face coated with an adhesive. An adhesive sublayer can also consist of a double face adhesive film, one face being bonded to the non-woven textile layer and the other face intended to be in contact with the floor.

Preferably, the woven reinforcement is produced from glass fibers, polyamide fibers or polyester fibers.

The woven reinforcement improves the rigidity and dimensional stability of the multilayer structure. The woven reinforcement is preferably woven according to a plain weave, although a twill weave or satin weave can be used. The weave is preferably produced from glass fibers, polyamide fibers or polyester fibers.

The first and second adhesive layers make it possible to bond between them the upper wear layer and the woven reinforcement as well as the woven reinforcement and the non-woven textile layer. Polyurethane glue can be used for the first and/or the second adhesive layer. Alternatively, the first and/or the second adhesive layer can consist of a thermosetting film or a double-faced film, i.e. a polymer film having an adhesive on both faces thereof.

Advantageously and in order to obtain a multilayer structure having antistatic properties, it is feasible to have the woven reinforcement be impregnated with a mixture comprising a plastic material and carbon black. Coating the woven reinforcement with a mixture comprising a plastic material and carbon black enables it to be impregnated. The woven reinforcement can also be impregnated by dipping into a mixture comprising a plastic material and carbon black. By way of example and in order to obtain a multilayer structure that can comply with NF EN 1815 (2016) standards, the woven reinforcement can be impregnated with a mixture of vinyl polyacetate (PVAC) and carbon black to obtain an impregnation of 10 to 40 g of said mixture per square meter of woven reinforcement. Sandwiched between the upper wear layer and the non-woven textile layer, the woven reinforcement in the multilayer structure makes it possible to completely dissipate the electric charges present on the upper face of the upper wear layer throughout the surface of the multilayer structure.

Advantageously, the woven reinforcement is impregnated with a thermoplastic or thermosetting polymer. In order to obtain a multi-layer structure having greater rigidity and limiting telegraphing phenomena, it is feasible for the woven reinforcement to be impregnated with a thermosetting polymer. The thermosetting or thermoplastic polymer can be chosen particularly from the group comprising polyester resin, phenolic resin, epoxy resin, polysulfone, vinyl ester resin, epoxy acrylic resin, and mixtures thereof.

The upper wear layer gives the floor covering durability and soil-resistant properties. The upper wear layer is for example produced from polyvinyl chloride or polyurethane and generally has a thickness of between 0.15 and 1 mm, preferably between 0.35 and 0.60 mm. The wear layer can be produced by any known means, particularly by calendering or extrusion through a slot die.

The upper wear layer is preferably transparent in visible light so the decoration of the printed film bonded to the backing of the wear layer can be seen through the upper wear layer.

Thus, the multilayer structure can advantageously comprise a layer of printed decorative film between the upper wear layer and the first adhesive layer.

The decorative film is printed directly by any known technique such as rotogravure or digital printing. A wide variety of decorations can be offered thereby. Digital printing solutions make it possible to achieve very realistic decoration. In particular, the printed film can be a polymer film. Alternatively, a decoration can be printed directly onto the back of the transparent upper wear layer.

Preferably, the multilayer structure comprises one or more intermediate layers of plastic material between the printed decoration film layer and the first adhesive layer.

The intermediate layer(s) makes it possible to decrease the toxicity of fumes generated by the combustion of the surface layer and/or the printed polymer film, particularly when they are produced from polymers that are not self-extinguishing.

Preferably, the multilayer structure comprises, between the second adhesive layer and the non-woven textile layer comprising self-extinguishing fibers, a second woven reinforcement impregnated with a thermosetting polymer bonded by a third adhesive layer. The second woven reinforcement impregnated with a thermosetting polymer contributes greater rigidity to the structure and makes it possible to limit the telegraphing phenomena. In particular, the thermosetting polymer can be a phenolic resin. The third adhesive layer can be produced from polyurethane glue or can consist of a hot melt film or double face film, i.e. a polymer film having adhesive on both faces thereof.

### BRIEF DESCRIPTION OF THE FIGURES

Further advantages and features will become more apparent from the following description of the multilayer structure, given by way of a non-limiting example and based on the attached drawings, in which:

FIG. 1 is a schematic view in cross-section of a first embodiment of the multilayer structure;

FIG. 2 is a schematic view similar to that of FIG. 1, illustrating a second embodiment of the multilayer structure;

FIG. 3 is a schematic view similar to that of FIG. 1, illustrating a third embodiment of the multilayer structure;

FIG. 4 is a schematic view similar to that of FIG. 1, illustrating a fourth embodiment of the multilayer structure.

### DETAILED DESCRIPTION

The present disclosure concerns a multilayer structure (1) for the production of a floor covering, particularly for passenger transport vehicles, for example in the aeronautics industry. The multilayer structure (1) has good fire-resistant properties, better durability than carpeting and better properties for cleaning, dimensional stability and limitation of telegraphing.

The multilayer structure (1) can be in any form, particularly as a panel, tile, and preferably in roll form.

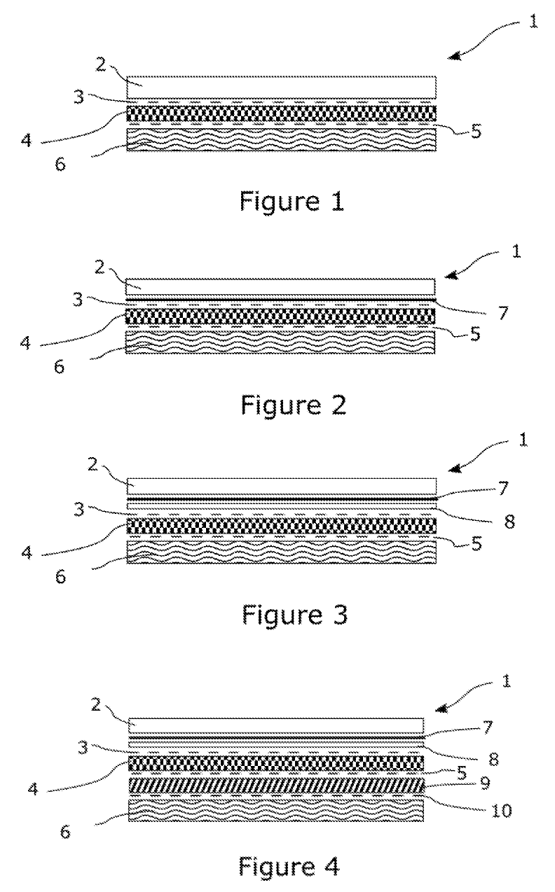

With reference to FIGS. 1 to 4, the multilayer structure (1) successively comprises an upper wear layer (2) of plastic material, a first adhesive layer (3), a woven reinforcement (4), a second adhesive layer (5), a non-woven textile layer (6) comprising self-extinguishing fibers, said layers being bonded together to form the multilayer structure (1). The main functions of the upper wear layer (2) of plastic material are control of slipperiness, resistance to wear and ease of cleaning. The upper wear layer can possibly be embossed or varnished on the surface.

The upper wear layer (2) can consist of a calendered or extruded layer, or even pressed. It can in particular be obtained from plasticized PVC. In general, and in a manner well known to the person skilled in the art, a wear layer may be obtained from a composition comprising a polymer, for example PVC or polyurethane, a plasticizer and possibly fillers, stabilizers, lubricants, additives and pigments. The upper wear layer can consist of one or more layers.

The woven reinforcement (4) can, with difficulty, be bonded with a layer of plastic material or a non-woven textile layer (6) using conventional hot-lamination techniques. If the upper wear layer (2) is hot-laminated onto the woven reinforcement (4), adherence is poor and easily delaminates. Thus, the upper wear layer (2) is not directly bonded to the woven reinforcement (4) without an intermediate layer. As a result, the first and second adhesive layers (3, 5) make it possible to bond the upper wear layer (2) to the woven reinforcement (4) and the woven reinforcement to the non-woven textile layer without risk of delamination. The first and/or the second adhesive layer can be achieved with polyurethane glue. Alternatively, the first and/or the second adhesive layer may consist of a hot melt film such as a co-polyamide film or thermoplastic polyurethane (TPU) or a copolyester film (coPes).

The woven reinforcement (4) improves the rigidity and dimensional stability of the multilayer structure. The woven reinforcement (4) is preferably woven according to a plain weave, although a twill weave or satin weave can be used. The weave (4) is preferably produced from glass fibers, polyamide fibers or polyester fibers. In particular, the glass fibers can have a linear density of between 22 Tex and 68 Tex. The polyester fibers can have a linear density on the order of 1100 decitex. In particular, the polyamide fibers can have a linear density of between 44 decitex and 78 decitex.

The woven reinforcement (4) generally has a thickness of between 150 μm and 300 μm, preferably between 215 μm and 225 μm. The woven reinforcement (4) generally has a surface weight of between 150 and 300 g/m², although this value depends on the type of fibers used.

Advantageously, the woven reinforcement (4), particularly when it is produced from glass fibers, has between 17 and 18 warp yarns per centimeter, and between 13.5 and 14 weft yarns per centimeter. Below 17 warp yarns per centimeter or 13.5 weft yarns per centimeter, the woven reinforcement (4) obtained is too porous, particularly with a linear density between 22 and 68 Tex. Above 18 warp yarns per centimeter or 14 weft yarns per centimeter, the woven reinforcement is difficult to produce with conventional production tools, particularly with a linear density of between 22 and 68 Tex.

The non-woven textile layer (6) comprises self-extinguishing fibers so as to improve the fire resistance of the multilayer structure while improving the walking comfort of the floor covering. The non-woven textile layer can in particular comprise fibers chosen from among fibers of polyetherimide, polyester, polyacrylate, aramide, para-aramide, oxidized polyacrylonitrile, aromatic polyamide and mixtures thereof. The quantity of each type of fiber can easily be adapted by the person skilled in the art to achieve an oxygen limiting index value greater than 0.21, than 0.28 or than 0.32 in compliance with NF EN ISO 4589-2/A1 standards, particularly from oxygen limiting index values of each type of fiber used in producing the non-woven textile layer and in accordance with the desired applications.

In order to improve the comfort of the floor covering while preserving good fire-resistant properties and limiting manufacturing costs, the non-woven textile layer (6) can be produced from a mixture of polyester fibers and polyetherimide fibers, a mixture of polyester fibers and aramide fibers, a mixture of polyacrylate fibers and aramide fibers, a mixture of polyester fibers and aramide fibers, or a mixture of oxidized polyacrylonytrile fibers and para-aramide fibers.

The non-woven textile layer (6) can be produced by any known means, particularly by dry process, melt bonding, wet-laid process or by formation in situ. Known techniques for consolidating the non-woven textile layer (6) can also be employed, particularly chemical or hydraulic consolidation. Preferably, the non-woven textile layer (6) is produced by a dry process comprising a consolidation step using needle punching that binds the fibers together.

Preferably, the fibers of the non-woven textile layer (6) are not partially or even totally impregnated with a thermoplastic and/or heat-setting resin in order to not limit their displacement in the non-woven textile layer (6) and to preserve good flexibility properties.

The non-woven textile layer (6) generally has a thickness of between 0.5 mm and 1 cm, preferably between 3 mm and 5 mm. A thickness of less than 3 mm generally reduces the walking comfort of the multilayer structure. A thickness of more than 5 mm significantly degrades the resistance to puncturing of the multilayer structure. A thickness of the non-woven textile layer (6) of between 3 mm and 5 mm offers a good compromise between comfort and resistance to puncturing.

The non-woven textile layer (6) advantageously has a surface weight of between 50 g/m² and 1000 g/m², preferably between 250 g/m² and 450 g/m². A surface weight of more than 450 g/m² can reduce the resistance to puncturing of the multilayer structure (1). However, a surface weight of less than 250 g/m² can improve resistance to puncturing but it decreases walking comfort. A surface weight of between 250 g/m² and 450 g/m² offers a good compromise between comfort and resistance to puncturing.

According to a first embodiment illustrated in FIG. 1, the multilayer structure (1) successively comprises an upper wear layer (2) of plastic material, a first adhesive layer (3), a woven reinforcement (4), a second adhesive layer (5), a non-woven textile layer (6) comprising self-extinguishing fibers, said layers being bonded together to form the multilayer structure (1). The upper wear layer of plastic material (2) is bonded to the woven reinforcement (4) by means of the first adhesive layer (3). The woven reinforcement (4) is bonded to the non-woven textile layer (6) by means of a second adhesive layer (5).

According to a second embodiment illustrated in FIG. 2, the multilayer structure (1) successively comprises a transparent upper wear layer (2) of plastic material, a printed decorative film (7) disposed between the upper wear layer (2) and the first adhesive layer (3) and, visible through the upper layer (2), a first adhesive layer (3), a woven reinforcement (4), a second adhesive layer (5) and a non-woven textile layer comprising self-extinguishing fibers, said layers being bonded together to form the multilayer structure (1).

The printed decorative film (7) is printed directly by any known techniques such as rotogravure or digital printing techniques. A wide variety of decorations can thereby be offered. The printed film can in particular be a polymer film produced from polyvinyl chloride (PVC), polyethylene terephthalate glycol (PETG) or poly(ethylene terephthalate) (PET), with a thickness generally between 0.2 and 0.5 mm. The printed decorative film (7) and the upper wear layer (2) are bonded by any known means such as hot lamination.

In this embodiment the printed decorative film (7) cannot be hot laminated onto the woven reinforcement (4) in order to bond them together. The first adhesive layer (3) does make it possible to bond the printed decorative film (7) to the woven reinforcement (4) without risk of delamination.

According to a third embodiment illustrated in FIG. 3, the multilayer structure (1) successively comprises a transparent upper wear layer of plastic material (2), a printed decorative film (7) visible through the upper layer (2), an intermediate layer of plastic material (8) disposed between the printed decorative film layer (7) and a first adhesive layer (3), a woven reinforcement (4), a second adhesive layer (5) and a non-woven textile layer comprising self-extinguishing fibers.

The intermediate layer of plastic material (8) makes it possible to reduce the toxicity of fumes generated by the combustion of the surface layer and/or the printed polymer film, particularly when they are produced from polymers that are not self-extinguishing. For example, it is possible to produce a multilayer structure comprising an upper wear layer of thermoplastic polyurethane (TPU) and/or a printed polymer film of polyethylene terephthalate glycol (PETG) in association with an intermediate layer produced from polyvinyl chloride (PVC). The presence of the intermediate layer produced from PVC makes it possible to limit the propagation of flames and the appearance of toxic fumes during combustion of the multilayer structure. In particular, this embodiment makes it possible to obtain a floor covering that complies with ABD0031 standards. The thickness of the intermediate layer is generally between 0.2 mm and 0.5 mm.

In this embodiment, the intermediate layer of plastic material (8) cannot be hot laminated onto the woven reinforcement (4) in order to bond them together. The first adhesive layer (3) enables the intermediate layer of plastic material (8) to be bonded to the woven reinforcement (4) without risk of delamination.

According to a fourth embodiment illustrated in FIG. 4, the multilayer structure (1) successively comprises a transparent upper wear layer (2) of plastic material, a first adhesive layer (3), a woven reinforcement (4), a second adhesive layer (5), a second woven reinforcement impregnated with a heat setting polymer (9), a third adhesive layer (10) and a non-woven textile layer comprising self-extinguishing fibers (6). The second woven reinforcement impregnated with a thermosetting polymer (9) contributes greater rigidity to the structure (1) and makes it possible to limit the telegraphing phenomena. In particular, the thermosetting polymer can be a phenolic resin. The third adhesive layer (10) can be produced from polyurethane glue or can consist of a hot melt film or double face film, i.e. a polymer film having an adhesive on both faces thereof.

### Example 1

A multilayer structure (1) is produced as described in FIG. 2.

Said multilayer structure (1) successively comprises:
A transparent upper wear layer (2) of calendered PVC 0.45 mm thick
A printed decorative film (7) of PVC 0.3 mm thick. The decorative film is printed by digital printing then complexed onto the upper wear layer by a hot lamination process.
A first polyurethane glue layer (3) 35 g/m²
A woven reinforcement (4) of glass fibers of 68 Tex. The reinforcement has a plain weave, a surface weight of 219 g/m², a thickness of 0.2 mm, 17.4 warp yarns per centimeters and 13.8 weft yarns per centimeter
A second polyurethane glue layer (5) 90 g/m²
A non-woven textile layer (6) of 300 g/m² and 3 mm thick. The non-woven textile layer is produced from a mixture of polyetherimide and polyester fibers. Said non-woven textile layer is marketed by the National Non-woven Company under the commercial name KushnBlok® Composite Cushioning Felt (CCF).

The multilayer structure thus formed can be used as floor covering in the aeronautics industry in roll form.

Different tests are performed on the floor covering thus obtained. The results of these tests are given in Table 1.

TABLE 1

| Test | Standard | Value |
|---|---|---|
| Abrasion resistance | ISO9352 (2012) | 143 ± 3 mg |
| Resistance to indentation - | NF EN ISO 24343- | 0.4 mm |
| puncture | 1 (April 2012) | |
| Fire resistance | | |
| Duration of combustion | FAR 25.853 | 4 ± 1 s |
| Burned length | | 80 ± 10 mm |
| Duration of combustion of drops | | 0 s |
| Slipperiness | FAR 25.793 | |
| Dynamic friction coefficient on | MIL-W-5044C | 0.55 ± 0.01 |
| dry leather | | |
| Weight | ISO 2286 (2016) | 1533 ± 12 g/m² |
| Thickness | ISO 2286 (2016) | 4.52 ± 0.08 mm |
| Dimensional stability L | ISO 23999 (2012) | 0.10 ± 0.03% |
| Dimensional stability T | ISO 23999 (2012) | 0.10 ± 0.04% |

The results of these tests show that the floor covering is sufficiently durable to satisfy the tests of resistance to abrasion and to puncturing according to ISO 9352 (2012) and the NF EN ISO 24343-1 (April 2012). Furthermore, a visual examination shows no defects on the upper face of the surface layer due to telegraphing of asperities of the support.

The floor covering thus obtained also complies with FAR 25.853 standards in terms of fire resistance, which makes its use possible in aircraft.

The dimensional stability results according to EN 434 standards are also very satisfactory. Walking comfort of the floor covering thus obtained is very satisfactory, the non-woven textile layer giving it good cushioning.

It can be seen from the foregoing that the described embodiments clearly provide a multilayer structure for the production of a floor covering, particularly for passenger transport vehicles, having good fire-resistant properties, while having very good durability and good properties of cleaning and dimensional stability. In particular, the described embodiments make it possible to obtain a floor covering complying with FAR 25.853 standards.

### Example 2

A multilayer structure (1) is produced, similar to example 1.

Said multilayer structure (1) successively comprises:
A transparent upper wear layer (2) of calendered PVC 0.45 mm thick
A printed decorative film (7) of PVC 0.3 mm thick. The decorative film is printed by digital printing then complexed onto the upper wear layer by a hot lamination process.
A first polyurethane glue layer (3) 35 g/m²
A woven reinforcement (4) of glass fibers of 68 Tex. The reinforcement has a plain weave, a surface weight of 219 g/m², a thickness of 0.2 mm, 17.4 warp yarns per centimeters, 13.8 weft yarns per centimeter
A second polyurethane glue layer (5) 90 g/m²
A non-woven textile layer (6) of 300 g/m² and 3.2 mm thick. The non-woven textile layer is produced from a mixture of polyetherimide fibers and polyester fibers. This non-woven textile layer has an oxygen limiting index of 41.3% (0.413).

The floor covering thus obtained is sufficiently durable to satisfy the tests of resistance to abrasion and to puncturing according to ISO 9352 (2012) and NF EN ISO 24343-1 (April 2012). Furthermore, a visual examination shows no defects on the upper face of the surface layer due to telegraphing of asperities of the support.

The floor covering thus obtained also complies with FAR 25.853 standards in terms of fire resistance, which makes its use possible in aircraft.

The dimensional stability results according to EN 434 standards as well as the walking comfort of the floor covering thus obtained are very satisfactory, the non-woven textile layer giving it good cushioning.

### Example 3

A multilayer structure (1) is produced similar to example 2, the only difference being that the non-woven textile layer (6) has a surface weight of 250 g/m² and a thickness of 2.7 mm. The non-woven textile layer is produced from a mixture of aramide fibers and polyacrylate fibers. This non-woven textile layer has an oxygen limiting index of 33.1% (0.331).

The floor covering thus obtained is sufficiently durable to satisfy the tests of resistance to abrasion and to puncturing according to ISO 9352 (2012) and NF EN ISO 24343-1 (April 2012). Furthermore, visual examination shows no defects on the upper face of the surface layer due to telegraphing of asperities of the support.

The floor covering thus obtained also complies with FAR 25.853 standards in terms of fire resistance, which makes its use possible in aircraft.

The dimensional stability results according to EN 434 standards as well as walking comfort of the floor covering thus obtained is very satisfactory, the non-woven textile layer providing good cushioning.

1. A multilayer structure for the production of a floor covering of a transport vehicle, said multilayer structure successively comprising an upper wear layer of plastic material, a first adhesive layer, a woven reinforcement, a second adhesive layer, a non-woven textile layer comprising self-extinguishing fibers, said layers being bonded together to form the multilayer structure.

2. The multilayer structure according to claim 1, wherein the non-woven textile layer has an oxygen limiting index of more than 0.28 in accordance with NF EN ISO 4589-2/A1 standards.

3. The multilayer structure according to claim 2, wherein the non-woven textile layer has an oxygen limiting index of more than 0.32 in accordance with NF EN ISO 4589-2/A1 standards.

4. The multilayer structure according to claim 1, wherein the non-woven textile layer comprises fibers chosen from among fibers of polyetherimide, polyester, polyacrylate, aramide, para-aramide, oxidized polyacrylonitrile, aromatic polyamide and mixtures thereof.

5. The multilayer structure according to claim 4, wherein the non-woven textile layer is produced from a mixture of polyester fibers and polyetherimide fibers, a mixture of polyester fibers and aramide fibers, a mixture of polyacrylate fibers and aramide fibers, a mixture of polyester fibers and aramide fibers, or a mixture of oxidized polyacrylonytrile fibers and para-aramide fibers.

6. The multilayer structure according to claim 1, wherein the woven reinforcement is produced from glass fibers, polyamide fibers or polyester fibers.

7. The multilayer structure according to claim 1, further comprising a layer of printed decorative film disposed between the upper wear layer and the first adhesive layer.

8. The multilayer structure according to claim 7, further comprising an intermediate layer of plastic material, disposed between the layer of printed decorative film and the first adhesive layer.

9. The multilayer structure according to claim 1, wherein the woven reinforcement is impregnated with a thermoplastic or thermosetting polymer.

10. The multilayer structure according to claim 9, wherein the woven reinforcement is impregnated with a mixture comprising a plastic material and carbon black.
